(19) United States
(12) Patent Application Publication
(10) Pub. No.: US 2006/0046243 A1
(43) Pub. Date: Mar. 2, 2006

(54) Method for vitrification of mammalian cells

(75) Inventors: James Joseph Stachecki, Parsippany, NJ (US); Steen Malte Willadsen, Windemere, FL (US)

Correspondence Address: James J. Stachecki;Suite 501, 101 Old Short Hills Road, West Orange, NJ, 07052, US

(73) Assignee: Tyho-Galileo Research Laboratories

(21) Appl. No.: 11/105,918

(22) Filed: Apr. 14, 2005

Related U.S. Application Data
(60) Provisional application No. 60/605,306, filed on Aug. 27, 2004.

(51) Int. Cl. A01N 1/02; A01N 1/00

(52) U.S. Cl. 435/1.3

(57) ABSTRACT

A method of vitrifying mammalian cells. According to the method of the present invention, biological cells of mammalian origin are frozen quickly by a vitrification method. Upon exposure to a coolant, the biological cells undergo vitrification. The biological cells which have undergone vitrification may be stored for a period of time and then devitrified at a later date. The devitrified biological cells remain viable. Preferred biological cells according to the present invention are developmental cells including blastocysts, embryos, and oocytes.

### CLAIM OF PRIORITY

This application claims priority from U.S. Provisional Patent Application No. 60/605,306, filed Sep. 24, 2004 and from U.S. Disclosure Document No. 559930, filed Aug. 30, 2004.

### TECHNICAL FIELD

This invention relates to a method for vitrification of a mammalian biological specimen, such that the biological specimen remains viable after it is thawed.

### BACKGROUND OF THE INVENTION

The ability to cryopreserve oocytes, embryos, blastocysts, and other similar biological specimens is important for the discriminate and widespread application of assisted reproductive technologies. Conventional cryopreservation protocols routinely use slow-cooling for the storage of cells, however survival and development are poor with certain cell types, including oocytes and blastocysts. Due to the large volume and/or complexity of some cells and the high chilling sensitivity of oocytes and early embryos, cryopreservation techniques are not well developed in most species.

Current cryopreservation methods involve the use of low concentrations of cryoprotectants, in the 1 to 1.5 M range, and slow cooling rates, in the range of 0.1-0.3 degrees C. per minute. Although these methods are somewhat successful for certain cell types including pronuclear and cleavage-stage embryos, they do not result in high survival and development rates following thawing for other cell types including oocytes and blastocysts.

The idea of vitrification or achieving a glass-like state was first described in 1860, and then again in 1937 by Luyet. It wasn't until nearly fifty years later in 1985 that Rall and Fahy described vitrification as a potential alternative to slow-cooling. Although relatively successful for oocyte and embryo storage of several species including bovine, murine, and porcine, (Martino et al., 1996; Shaw et al., 1992; Vajta et al., 1998) vitrification has not so far given consistent and reproducible results when used for storing human oocytes or embryos (Kasai and Mukaida, 2004). Nevertheless, there have been numerous recent publications on human embryo vitrification (Ali, 2001; Chen et al., 2000; Cho et al., 2002; Chung et al., 2000; Cremades et al., 2004; Hiraoka et al., 2004; Hong et al., 1999; Hunter et al., 1995; Kasai and Mukaida, 2004; Kuleshova et al., 1999; Kuleshova and Lopata, 2002; Lane et al., 1999; Liebermann et al., 2003; Liebermann et al., 2002; Mukaida et al., 2003a; Mukaida et al., 2003b; Son et al., 2003; Stachecki and Cohen, 2004; Vanderzwalmen et al., 2003; Vanderzwalmen et al., 2002; Wu et al., 2001; Yokota et al., 2000; Yokota et al., 2001; Yoon et al., 2003).

Cryobiological vitrification is characterized by the avoidance of intracellular crystal formation during cooling and low temperature storage. Vitrification is a feature of most if not all successful cryopreservation of living cells, since the formation and growth of ice crystals intracellularly has been identified, although indirectly, as one of the main causes of cell damage and death in the context of cryopreservation. In conventional cell cryopreservation the vital role played by vitrification is hidden behind the issues of temperature and cooling rate, whereby the vitrified state is, almost unwittingly, achieved. Hence, alternative ways of achieving vitrification have been almost completely ignored in conventional cell cryopreservation, which has at any rate remained a surprisingly empirical and practical enterprise.

Certain non-conventional cryopreservation procedures identify vitrification as the operative aim of cell cryopreservation. These vitrification methods involve exposure of the cells to high concentrations of cryoprotectant(s) for brief periods of time, prior to cooling, usually at or near room temperature, followed by rapid cooling in liquid nitrogen. The high osmolarity of the vitrification solution rapidly dehydrates the cell and submersion into liquid nitrogen quickly solidifies the cell so that the remaining intracellular water does not have time to form damaging ice crystals. The same end result is acheived during successful slow-cooling where the cells are dehydrated over a longer period of time and then plunged into liquid nitrogen from much lower temperatures. Modern vitrification methods aim to mimic the extra- and intra-cellular conditions that exist at an intermediate low temperature arrived at via a slow cooling process (around 30° C.) and are known to allow for survival when cells are subsequently transferred directly to LN₂.

However, such vitrification procedures can pose a threat to cell survival because of the toxicity at above freezing temperatures of the highly concentrated cryoprotectants (Hotamisligil et al., 1996; Mukaida et al., 1998). The higher risk involved with vitrification limited the number of attempts to use this technique for human oocyte storage until Kuleshova et al., (1999) documented the birth of a healthy girl from an oocyte vitrified in an open-pulled straw, the method being adopted from a successful bovine vitrification study (Vajta et al., 1998). Vitrification of human embryos and blastocysts is more widespread, although few clinics have experienced real or consistent success (for review see Liebermann et al., 2002).

Although vitrification is well on its way to being used clinically to freeze oocytes, cleavage stage embryos, and blastocysts, some important concerns need to be addressed. First, several reports of viral contamination in liquid nitrogen have appeared in the literature and are cause for concern whenever unsealed containers are used (Kuleshova and Shaw, 2000). Secondly, the common procedure of placing cells into a highly concentrated vitrification solution, loading them onto a grid, loop, or into a straw, and plunging, all in less than 30 sec, remains technically challenging; and more importantly, leaves little or no room for error. Thirdly, the consistency of results with vitrification protocols is often poor. An often claimed average survival rate of around 70% may be considered good only if the sample size is large enough to allow a convincing average to be calculated (Liebermann et al., 2002).

Prior vitrification methods for oocytes, embryos, and blastocysts have been only somewhat successful. These vitrification procedures rely on 1) increasing the cooling rate to reduce the time the cells are exposed to toxic concentrations of cryoprotectants. This objective has been achieved by plunging cells held in or on open containers or transfer instruments including electron microscopy grids, cryo loops, paddles, nets, or within thin-walled straws (known as open pulled straws) directly into liquid nitrogen, and 2) limiting the time of exposure to the highly concentrated cryoprotectant solutions to under 45 seconds and preferably to under 30 seconds prior to cooling. However, these techniques are tricky to execute and leave virtually no time to recover if an error should occur when preparing the cells for cooling. Also these procedures involve direct contact of the cells with the coolant, in nearly all cases liquid nitrogen, which may contain live viruses and other contaminants. Even a cryo loop, which is fairly simple device to use, does not avoid the problems mentioned above.

Furthermore survival rates in the case of embryos are usually given on a “per embryo” basis, and not on a “per blastomeres” basis. For example an embryo or blastocysts may be deemed to have survived if 50% or more of the cells that make up the embryo or blastocyst are intact. This means that 50% of all blastomeres may have been destroyed, and still the embryo is deemed to have survived. This is very misleading. A more stringent evaluation of embryo survival is to report survival rates on a per cell basis.

There is a definite need of a vitrification method which allows the viability of the specimen to be maintained, allows the specimen to be sealed in a sterile container thus avoiding direct contact with the coolant; provide adequate time for and ease of cryopreservation and recovery manipulations; and result in high survival rates both on a per embryo and on a per cell basis. The present invention fills that need.

### SUMMARY OF THE INVENTION

The present invention relates to a method of vitrification of a biological specimen. According to the method of the present invention, a biological specimen is indirectly exposed to a coolant. Upon indirect exposure to the coolant, the biological specimen undergoes vitrification. The biological specimen which has undergone vitrification may be stored for any period of time, thawed at a later date, and yet is still viable after thawing. Preferred biological specimens according to the present invention are mammalian developmental cells.

The present invention relates to a method of vitrification that includes the use of a sealed container, such as a straw, pulled-straw, vial, ampule, or other minute sterile container that is sealable to hold the biological specimen, with a straw being a preferred container. The sealed container can be placed directly into a coolant such as liquid nitrogen or liquid nitrogen vapors. The biological specimen then undergoes vitrification. The straw containing the vitrified biological specimen may be stored at ultra-low temperature (typically in liquid nitrogen) until such time as the biological specimen is required for use.

A further aspect of the present invention is the treatment of the biological specimen with one or more cryoprotectants prior to vitrification.

The invention also relates to a method for thawing a biological specimen which has undergone vitrification. The thawing methodology comprises the removal of the biological specimen from the coolant wherein it has been vitrified, placing the biological specimen in a thaw solution, and the removal of cryoprotectant(s).

A further aspect of the present invention is a method of vitrification of developmental cells, wherein one or more developmental cells are placed into a container which is then sealed and placed into a coolant, such that each developmental cell is not directly exposed to the coolant, yet undergoes vitrification, wherein the vitrified developmental cells, when thawed, cultured and/or implanted into suitable host organisms, will result in a fertility rate equal to that of the same developmental cells, had they not been vitrified. Preferably, the developmental cells are contained within a sealed straw when exposed to the coolant. Preferably the straw is exposed to liquid nitrogen vapors for vitrification to occur rather than being directly placed in liquid nitrogen.

The present invention also relates to a method of vitrification of a mammalian blastocyst or mammalian cleavage stage embryo which comprises placing one or more blastocysts or cleavage stage embryos in a coolant, such as liquid nitrogen vapors, such that each blastocyst or cleavage stage embryo is indirectly exposed to the coolant, thereby undergoing vitrification, wherein at least 80 percent, and preferably, 90 percent or more, of the vitrified blastocysts or cleavage stage embryos will be viable after being thawed and cultured, preferably in the appropriate base medium. Preferably, the blastocyst or cleavage stage embryo is contained within a sealed straw when exposed to the coolant.

The present invention also relates to a kit for the vitrification of a biological specimen. The kit will generally contain instructions describing the vitrification of a biological specimen wherein the specimen is indirectly exposed to a coolant. The kit will also include one or more optional ingredients, including, but not limited to, a container, most preferably a straw, a base medium, and a cryoprotectant.

### DETAILED DESCRIPTION

In the present application, the following terms are used throughout and are defined for the purposes of this application as follows: Base Medium: A solid or liquid preparation made specifically for the growth, manipulation, transport, or storage of the biological specimen placed therein. Container: An instrument which can be sterilized, which the biological specimen can be placed in and then the container closed or sealed, including but not inclusive of a straw, an ampoule, and a vial. Cryopreservation: The preservation of a biological specimen in a viable state at ultra-low temperature. Developmental Cells: A reproductive body of an organism that has the capacity to develop into a new individual organism capable of independent existence. Developmental cells include, but are not limited to, sperm, oocytes, embryos, morulae, blastocysts, and other early embryonic cells, whether aggregated or isolated. Indirectly Exposed: A biological specimen, including a blastocyst and an embryo that resides in a sealed container, is “indirectly exposed” to a freezing material because the biological specimen is not allowed to come into direct contact with the coolant. Coolant: Any material, including but not limited to, liquid gases and their vapors, such as liquid nitrogen, liquid propane, liquid helium, or ethane slush, or dry ice which is capable of causing vitrification of a biological material. Viable: A biological specimen is viable if it retains the ability to function and develop normally for a period of time. Vitrification (Vitrify): A phenomenon wherein a biological specimen is cooled to very low temperatures under such conditions and in such a way that its contents solidify into a glass-like state without undergoing crystallization.

The present invention is directed to a method for the vitrification of biological specimens, based on U.S. Provisional Patent Application No. 60/605,306, the entire contents of which is hereby incorporated by reference.

The present invention has a number of uses. It may be used for animal husbandry, laboratory research, endangered species preservation, as well as for human assisted reproduction.

The present invention relates to a method whereby a biological specimen is exposed to cryoprotectants, loaded into a container, the container sealed, the container then placed in close association with or into a coolant which allows the specimen to vitrify the container with the biological specimen can then be stored in a coolant, thawed, and the biological specimen remains viable after thawing.

The biological specimen of the present invention can be any kind of viable biological specimen which is a living cell, but is preferably developmental cells, and more preferably mammalian developmental cells. Such cells can include, but are not limited to, sperm, ova, embryos, blastocysts, morulae, and oocytes. Such preferred cells can be from any desired mammalian source, including but not limited to: humans, non-human primates, rats, mice, hamsters, pigs, sheep, cows, goats, horses, genetically important species, and endangered species, etc. The use of other developmental cells from other living creatures is also within the scope of this invention, such as reptiles, amphibians, and insects such as Drosophila. Other suitable cells for use with the present invention include both stem cells, including human stem cells, and plant tissue cells.

In a preferred embodiment, the biological specimen is treated with a cryoprotectant prior to vitrification. The cryoprotectant(s) of the present invention can be permeating and/or nonpermeating and include but are not inclusive of: ethylene glycol, polyethylene glycol, dimethylsulfoxide, glycerol, propanediol, methylpentanediol, sugars, and high molecular weight compounds. The preferred permeating cryoprotectants are glycerol and ethylene glycol. The preferred sugars are glucose, trehalose, and sucrose. The preferred non-permeating cryoprotectants are ficoll and dextran. A preferred embodiment includes the cryoprotectants glycerol, ethylene glycol, and sucrose.

The duration of the treatment with cryoprotectants can affect the success of the procedure and adequate treatment time is needed for the method to be effective. Treatment can occur by a variety of methods, all achieving the same result of successful vitrification. The method of the present invention is to load the biological specimen with cryoprotectants and dehydrate the specimen at the same time. In a preferred embodiment of the invention, the biological specimen is treated with cryoprotectant(s) for 5 minutes to 50 minutes. Treatment with cryoprotectants can occur in one step or many steps over the duration of treatment. A preferred embodiment of the invention has the biological specimen treated with 3 solutions containing cryoprotectants in increasing concentrations. Thus the biological specimen is loaded with cryoprotectants to a degree that allows for successful vitrification. In a preferred embodiment of the invention the biological specimen is treated with a 10% cryoprotectant solution for 5 minutes, 30% cryoprotectant solution for 5 minutes, and a 50% cryoprotectant solution for 90 seconds. Various cryoprotectant solutions with various total concentrations for various durations can be successful. The method of the invention differs from the prior art in that longer treatment times with cryoprotectants are used and a series of increasing concentrations of cryoprotectants has unexpectedly proven effective, with a total duration of treatment of longer than 5 minutes. Prior art is less successful because the biological specimen, mainly developmental cells, were not loaded internally with cryoprotectants prior to vitrification. Prior art used short exposure times because longer exposure times under the conditions set were toxic.

The present invention unexpectedly and surprisingly avoids cryoprotectant toxicity and allows for longer exposure times.

The container of the present invention can be any minute container that is or can be sterilized, can hold one or more biological specimens, and can be closed or sealed so that the specimen is not lost and so that, importantly no coolant can enter the container during vitrification, storage, or rewarming. Such containers can including, but not inclusive of, a straw, a pulled straw, a vial, an ampoule, i.a. In a preferred embodiment the container is a straw. Other containers including but not inclusive of a net, paddle, open pipet, open pulled straw, loop, etc. will also be successful. However any container that cannot be sterilized and sealed will allow for potential contamination, mainly viral, when the specimen is exposed to liquid nitrogen, the most common freezing material, and thus are not suggested for use.

The methodology of the present invention whereby the container is placed in close association with a coolant allows for vitrification. The container can either be placed in close association with or directly in the coolant for a period of time that will allow for vitrification. Liquid nitrogen and/or its vapors are the preferred coolants. Liquid nitrogen vapor temperature can vary depending on the height above the liquid surface and can range from room temperature to −190° C. Placing the container with the biological specimen in liquid nitrogen vapors of various temperatures will allow for vitrification. A preferred embodiment has the container being placed into liquid nitrogen vapors with a temperature range of between −20° C. to −150° C. Another preferred embodiment of the invention has the container being placed into liquid nitrogen vapors with a temperature range of: −70° C. to −120° C. Still another preferred embodiment of the invention has the container being placed into liquid nitrogen vapors with a temperature range of: −95° C. to −105° C.

When the container is placed into the liquid nitrogen vapors, the specimen will vitrify. Vitrification occurs within several seconds, depending on the temperature of the vapors. Any time period that will allow for vitrification will work and is in the range of 5 seconds or longer. To assure that the specimen inside the container is vitrified a preferred embodiment of the invention has the container being placed into liquid nitrogen vapors for 2 minutes prior to storage in liquid nitrogen. Still another preferred embodiment of the invention has the container being placed into liquid nitrogen vapors for 1 to 20 minutes or longer prior to storage in liquid nitrogen.

After vitrification, the biological specimen, contained within the sealed container, can then be stored at ultra-low temperature indefinitely.

The method of the present invention is in contrast to previous prior art methods wherein the biological specimen was directly exposed to the coolant in an open container or treatment instrument rather than being enclosed within a container such as a sterile straw that has been sealed after the biological specimen has been placed inside. An open container or treatment instrument that is not sealed can allow for viral contamination.

After vitrification the biological specimen may be thawed, and the viable biological specimen may develop further. Thawing is accomplished by removing the container with the vitrified biological specimen from any storage tank in which it resides, and allowing it to devitrify before removing the specimen from the container into a thaw solution. In a preferred embodiment, the container is a straw, and the straw is thawed at a rate of less than 2000° C. per minute. In a preferred embodiment, the container is a straw, and the straw is held in 23° C. air for 1-10 seconds before plunging into a 20° C. water bath for 5-60 seconds. In a preferred embodiment, the container is a straw, and the straw is held in 23° C. air for 5 seconds before plunging into a 20° C. water bath for 10 seconds. The thaw solution may be any solution or material that is sufficient to allow the biological specimen to thaw while preserving its viability, including, but not limited to, any medium known in the art as appropriate as a base medium for the particular biological specimen. After thawing, the biological specimen can be further manipulated in any appropriate manner known for the species and process for which the specimen is being utilized.

Cryoprotectants, such as ethylene glycol, polyethylene glycol, dimethylsulfoxide, glycerol, propanediol, and sugars, as well as others well known in the art, can be toxic to biological specimens, including sensitive cells such as oocytes and embryos, when used in large dosages during cryopreservation. Therefore, to avoid cryoprotectant toxicity, prior art describes using reduced exposure periods to concentrated cryoprotectants prior to cooling of the biological specimen. These recommended time periods are in the range of 45 seconds or less, and generally 30 seconds or less. Although the vitrification procedures previously described in the art, allow for survival, they do not allow time for recovery in the event that errors in pipetting occur. Pipetting one or more cells into and out of cryoprotectant solutions and onto straws, grids, loops, or any other containing device described in the art, in a time period of only 45 seconds or less is technically challenging. Exposure to the concentrated cryoprotectant solutions for longer than 45 seconds has been described and demonstrated in prior art as being detrimental to cell survival.

The methodology of the present invention also allows for an increase in the time of exposure of the biological specimen to the solution phase of the cryoprotectant used, thus it may be argued that the toxicity of the cryoprotectant to the biological specimen is increased compared with methodologies in prior art. However, the survival rates the present method allows for are similar to, or higher than, those achieved by the prior art. Thus, the expected increase in cryoprotectant toxicity does not occur, is negligible, or does not significantly affect the success of the methodology described herein.

It has been surprising and unexpected that we obtained high survival rates after exposure to concentrated cryoprotectants prior to placement of the biological specimen into the cryoprotectant(s) for periods of 45 to 240 seconds. In a preferred embodiment, the exposure time is equal to or less than 120 seconds, and preferably less than 90 seconds. In the method of the present invention the biological specimen can be exposed to the final concentrated cryoprotectant solution for longer than 45 seconds, this allows more time to prepare the specimen for vitrification than the prior art. The extra time that the method of the present invention allows for greatly enhances the ease of use of this method and allows time for recovery should there be any technician error. This major difference makes the present invention superior to the prior art. There is another feature that is equally if not more important—cryoprotecant saturation.

In addition to the reduced exposure to cryoprotectants, prior art describes rapid cooling rates necessary for optimal survival rates of oocytes and embryos. High rates of cooling have been shown to prevent chilling injury to sensitive cells such as developmental cells. The extremely rapid cooling rate obtained with cryo loops, grids, nets, and other minute devices that lack an insulating layer and allow for direct contact of the specimen with the freezing material substantially reduces the exposure time to any cryoprotectants used and thereby reduces their cytotoxicity to the specimen. However, these devices allow the specimen to directly contact the coolant, namely liquid nitrogen, which may contain viruses and other contaminants.

Another surprising and unexpected result of the present invention is that cooling the biological specimen contained within a container, preferably straws, in liquid nitrogen vapors, a substantially different cooling regime than most that are described in the art, worked as well or better for the specimens tested and consistently allowed for over 80% survival and more often over 90% survival.

Prior art describes several successful methods for vitrification of biological specimens. However, the major benefits over the prior art are that the methodology described in the present invention: 1) allows for a sterile sealed container to be used, namely a straw, which is the most common device used for storing biological specimens, namely oocytes and embryos, thereby avoiding the possibility of viral and other contamination due to direct exposure to the coolant, inherent in the use of open containers; 2) allows the biological specimen be exposed to cryoprotectants for a longer duration, specifically during treatment with the highest cryoprotectant concentration where the exposure time can be up to 240 seconds, thereby making the method significantly easier to use and more importantly leaving time for recovery should a technician error occur during preparation of the specimen(s) for vitrification and to be equilibrated with the major intracellular cryoprotectants prior to cooling; and 3) allows for over 80%, and generally over 90%, surivial of the vitrified specimen(s), and more importantly over 90% survival of the cells that make up the specimen. Moreover, the present invention allows the vitrification of developmental cells, wherein the vitrified developmental cells, when thawed, cultured and implanted into suitable host organisms, can result in a fertility rate equal to that of developmental cells which are similarly implanted without having been cryopreserved. This helps solve the long standing problem of low pregnancy rates resulting from the use of certain cryopreserved developmental cells.

Additionally, the present methodology differs from prior art which placed the biological specimen on open plates such as microscopy grids, which were unable to allow for facile manipulation of the specimen when contained within the coolant during storage, making handling of the specimen difficult and ultimately resulting in a poor recovery of the vitrified specimen. The present invention allows better handling of the biological specimen and thereby solves the problem of specimen recovery known in prior vitrification methods, such as those employing microscopy grids.

By allowing for a different cooling regime, increased time of exposure of solution phase cryoprotectants, and reliable retention and ease of handling of the biological specimen, the present invention solves a long standing problem in the art of successful cryopreservation of sensitive biological specimens such as developmental cells.

It has been surprisingly and unexpectedly discovered that the use of a sealed straw in the present vitrification methodology allows slower cooling rates, ease of visualization, facile manipulations, and a consistently high success rate of viability when the vitrified specimen is thawed and cultured.

The present invention also relates to a kit for the vitrification of a biological specimen. The kit will generally contain instructions describing the vitrification of a biological specimen wherein the specimen is contained inside a sterile container and indirectly exposed to a coolant. The kit will also include one or more optional ingredients, including, but not limited to, a container, most preferably a straw, a base medium, from which vitrifying and thawing solutions can be prepared, and cryoprotectants.

The preferred embodiment of the present invention is a method for vitrification a biological specimen comprising the following steps:

Collecting one or more biological specimens (preferably blastocysts) by any means well known in the art.

Transferring the biological specimen to a solution containing one or more optional ingredients, such as a cryoprotectants, prior to vitrification. Preferably transferring the biological specimen to a solution containing one or more cryoprotectants ranging from 1% to 60% cryoprotectant concentration for a duration of 30 seconds to 30 minutes and at a temperature of 5° C. to 40° C. in a series consisting of 1 to 6 steps. More preferably transferring the biological specimen to 10% glycerol for 5 minutes at 23° C., followed by transferring the biological specimen to a mixture of 10% glycerol and 20% ethylene glycol for 5 minutes at 23° C., followed by transferring the biological specimen to a mixture of 25% glycerol and 25% ethylene glycol at 23° C.

Loading the biological specimen along with a small amount of cryoprotectant solution into a container and sealing the container. Preferably loading the biological specimen along with a small amount of 25% glycerol and 25% ethylene glycol into a straw, and more preferably loading a 1.5 cm column of 0.85 molar sucrose followed by a 0.5 cm column of air followed by the biological specimen along within a 2 cm column of 25% glycerol and 25% ethylene glycol, followed by a 0.5 cm column of air, followed by a 1.5 cm column of 0.85 molar sucrose, and sealing the straw, within a period of no more than 240 seconds, and more preferably no more than 90 seconds from initially placing the biological specimen into the 25% glycerol and 25% ethylene glycol cryoprotectant solution.

Placing the container in a coolant, allowing vitrification of the biological specimen. Preferably placing the straw into liquid nitrogen vapors so that it does not directly contact the liquid, and more preferably placing the straw into liquid nitrogen vapors at a temperature of 0° C. to −190° C., and more preferably at a temperature of −50° C. to −150° C., and more preferably at a temperature of −90° C. to −110° C.

Holding the container in liquid nitrogen vapors allowing vitrification of the biological specimen, preferably for a duration of 5 seconds to 50 minutes, more preferable for 2 minutes.

Thereafter, the biological specimen may be stored, preferably in liquid nitrogen, thawed, and the viable biological specimen may be further developed.

Thawing is accomplished by removing the container with the vitrified biological specimen from any storage tank in which it resides, and plunging the container and specimen into a thaw solution. Preferably removing the straw containing the vitrified biological specimen from any storage tank in which it resides and thawing it by holding it in room temperature air for 1 second to 10 seconds, preferably 5 seconds, and then submerging the straw into a 5° C. to 37° C. solution, preferably into 20° C. water for 1 second to 120 seconds, preferably for 10 seconds.

Removing the thawed biological specimen from the container and plunged into a thaw solution(s). The thaw solution may be any solution or material that is sufficient to allow the biological specimen to thaw while preserving its viability, including but not limited to, any medium known in the art that is appropriate as a base medium for the particular biological specimen.

Preferably removing the specimen from the straw and transferring the biological specimen to a solution containing one or more cryoprotectants ranging from 0% to 50% cryoprotectant concentration for a duration of 30 seconds to 10 minutes and at a temperature of 20° C. to 40° C. in a series consisting of 1 to 6 steps. And more preferably transferring the thawed biological specimen to 0.85 molar sucrose for 5 minutes at 23° C., then transferring the biological specimen to 0.4 molar sucrose for 5 minutes at 23° C., then transferring the biological specimen to 0.2 molar sucrose for 5 minutes at 23° C., then transferring the biological specimen to 0.1 molar sucrose for 5 minutes at 23° C., then transferring the biological specimen to base medium. The sucrose solutions are preferably made with media, including but not limited to a medium known in the art that is appropriate as a base medium for the particular biological specimen.

After thawing, the biological specimen can be further manipulated in any appropriate manner known for the species.

This invention is illustrated further by the following nonlimiting Examples. All of the references listed in the application are hereby incorporated by reference.

### EXAMPLE 1

### Vitrification of Bovine and Human Blastocysts

All human embryos were discarded material donated to research. For all embryos used, written consent was obtained from patients in accordance with each internal review board protocol. A human embryo on Day 5, 6, or 7 that had a visible blastocoel was designated as a blastocyst and vitrified. Most of the embryos had questionable inner cell mass quality, or poorly defined trophoblast and inner cell mass cells.

Bovine oocytes were purchased from BoMed (Madison, Wis.) and shipped overnight in a portable heated incubator. Oocytes were cultured for several hours in order for full maturation to occur (24 h from start of culture) before insemination with bull sperm. Oocytes were inseminated in IVF-TALP. After incubation with sperm overnight, the oocytes were washed and cultured in cSOF, supplemented with essential and non-essential amino acids (Gibco BRL). After 5 days of culture, good quality embryos (16-cell to Morulae) were transferred to fresh cSOF medium containing 10% FBS, and allowed to develop for an additional 2-3 days. On Day 7 and 8, embryos having a visible blastocoel, and expanded blastocysts were selected for vitrification.

Vitrification

Pilot studies were performed to determine optimal conditions for vitrification and subsequent development. The method used here involved a series of three vitrification solutions. The respective cell types were exposed to 10% glycerol (V1) for 5 min at room temperature (RT). The cells were transferred to 10% glycerol & 20% ethylene glycol (V2) for 5 min at RT, and then to 25% glycerol and 25% ethylene glycol (V3), making sure to minimize the amount of medium carried over. Once in V3, the cells were immediately loaded into a 0.25 cc straw (IMV; AgTech). All solutions were made up in ETFM or CJ2 (a choline-based freezing medium) supplemented with 20% fetal bovine serum (FBS, for bovine embryos) or 20% human serum albumin (HSA, for human embryos). Blastocysts were loaded into standard 0.25 cc straws in the following manner: a 25 mm column of 0.85M sucrose in ETFM or CJ2, followed by 5 mm of air, 15 mm of V3 which contained the cells to be vitrified, 5 mm of air, and 25 mm of 0.85M sucrose in ETFM or CJ2. Both ends of the straw were heat-sealed. The time it took to load a straw and seal it ranged from 50-90 sec. If loading and sealing took place in less than 50 sec, the straw was held at room temperature until 60 sec had elapsed from the time the cells were placed into V3, and then cooling began. For cooling, the straws were placed above LN2, in the vapor phase (approximately −100° C.; range −95° C. to −105° C., based on a thermocouple held at the same height as the blastocysts in the straw) for 2 min before being submerged and stored in LN2. This method of loading and cooling was easily accomplished, within the given time frame.

Thawing

Straws were thawed by holding them in room temperature air for exactly 5 sec before immersion into a 20° C. water bath for an additional 10 sec. After thawing, the content of the straw was expelled into a 100 ul drop of ETFM or CJ2 supplemented with 0.85M sucrose. The petri dish containing the drop was then shaken back and forth in gentle, but quick movements on the workbench for 30 sec to aid mixing of the solutions. The cryoprotectants were removed in a series of six, 5 min steps at RT. The cells were placed into 1) 0.85M sucrose; 2) 0.4M sucrose; 3) 0.2M sucrose; 4) 0.1M sucrose; 5) ETFM or CJ2, each for 5 min at RT and then 6) warmed for 5 min on a 37° C. slide warmer. All solutions were made in ETFM/CJ2 and contained 10% FBS (bovine blastocysts or HSA (human blastocysts). The blastocysts were then placed into cSOF with amino acids and 10% FBS at 39° C. (bovine) or KSOM with amino acids and 10% HSA at 37° C. (human) and cultured overnight.

Staining

Following 24 h of culture, blastocysts were scored for re-expansion of the blastocoel and then stained to determine the number of living and dead cells. Blastocysts were incubated in 10 ul/ml propidium iodide in Hepes-buffered KSOM with amino acids at 37° C. (human) or 39° C. (bovine) for 15 min. The blastocysts were then fixed in 5° C., 70% ethanol for 5 min, and incubated in 70% ethanol containing 10 ug/ml Hoechst at room temp for 5 min. The blastomeres were then placed in a small drop of mounting medium on a slide and a coverslip was gently placed on top. Care was taken to not rupture the blastocysts, but to flatten them in order to count the cells. The number of cells with a pink (dead), and blue (alive, membrane intact) nucleus were counted. Observations were made using a Nikon Diaphot with epifluorescence capabilities (Opti-Quip, Highland Mills, N.Y.).

Our vitrification results are shown in Table 1. The majority human and bovine blastocysts survived vitrification and thawing and re-expanded at a high rate. The blastocysts that had survived, had on average>90% intact blastomeres for both groups.

TABLE 1
Vitrification of Human and Bovine Blastocysts

| | n | Intact | Expanded | Intact Cells |
|---|---|---|---|---|
| Human | 32 | 24 (75%) | 19/22 (86.3%) | >90% |
| Bovine | 102 | 98 (96.1%) | 95/98 (96.9%) | 6340/6775 (93.6%) |

Our results using human blastocysts donated to research are not as successful as our results with bovine blastocysts, the human blastocysts were of sub-optimal quality and most likely had dead or degenerating blastomeres prior to vitrification, making accurate analysis difficult. These sub-optimal blastocysts were the only embryos that were available to test our vitrification protocol. By contrast, only the best bovine blastocysts (expanded blastocoel with a clearly defined inner cell mass) that were developed from in vitro matured oocytes, were selected for vitrification. We assumed that all the blastomeres in these embryos were intact upon vitrification. Over the course of our experiments we consistently achieved some of the highest survival and re-expansion rates reported to date. To determine exactly how many blastomeres were intact following thawing, we cultured the blastocysts overnight and stained them the next day with a vital stain. Some cells will look alive immediately after thawing, however following culture for several hours, they will die. Culturing the cells overnight gave us a better indication of how many cells died from vitrification. We obtained 93.6% survival of over 6700 cells. The few experiments we have done with high quality human blastocysts (used in an ongoing clinical investigation with full IRB approval) have yielded 100% embryo survival and expansion rates (n=3) and 2 fetuses are currently developing.

We have developed, and describe herein, a highly effective and reproducible method for the vitrification of mammalian blastocysts, specifically human and bovine. This method was developed after failure to find an effective established protocol for the storage of human blastocysts. We have successfully avoided several problems related to storage conditions and viral contamination during vitrification by using sealed straws, the favored method routinely used by IVF clinics to store human embryos. Our method described herein contrasts with the popular use of minute storage containers such as loops, electron microscopy grids, nets, paddles, open-pulled straws, finely pulled glass pipets, etc. Not only have we used 25 cc straws for storage, we have cooled the cells more gradually in liquid nitrogen vapors rather than by direct plunging into liquid nitrogen or chilled liquid nitrogen, again in contrast to popular trends in vitrification research which suggest that the faster the cooling rate, the greater the survival. We have developed this protocol to be easy to use and eliminated the problem of rapid transfer of embryos into the final vitrification solution, then into a storage container, and then into liquid nitrogen within 25 to 45 seconds. Although most vitrification protocols start cooling within 30 to 45 seconds of submersion into the final vitrification solution, this is very difficult to consistently achieve, and there is no room for user error.

Here again, popular belief is that lengthy exposure to the final vitrification solution is harmful to cells. Many investigations including our own unpublished results suggest that exposure longer than 30 seconds can be detrimental to survival. However, we needed to modify the protocol in order to make the whole procedure as easy and effective as possible and provide a workable time frame that allowed for some technician slowness or error, as the pipetting of embryos into viscous solutions, loading them into a container, sealing the container, and transferring the container with the embryos or cells to liquid nitrogen is difficult to do within 30-45 seconds, and significantly easier in 90-120 seconds. We have achieved our goal and herein present this novel method for the vitrification of mammalian blastocysts.

To our knowledge, a method such as this, which is successful (greater to or equal to 80% survival for the entire embryo and all blastomeres), and reproducible (many vitrification protocols have been difficult to reproduce between and even within laboratories) has not been established. The method described herein may prove useful for the storage of other cell types such as preimplantation stage embryos and oocytes from mammalian species other than bovine and human.

It is understood that the invention is not confined to the particular embodiments set forth herein as illustrative, but embraces all such modified forms thereof as come within the scope of the following claims.

### BRIEF DESCRIPTION OF THE DRAWINGS

FIG. 1 is a schematic illustrating a straw loaded with cells to be vitrified according to the present invention.

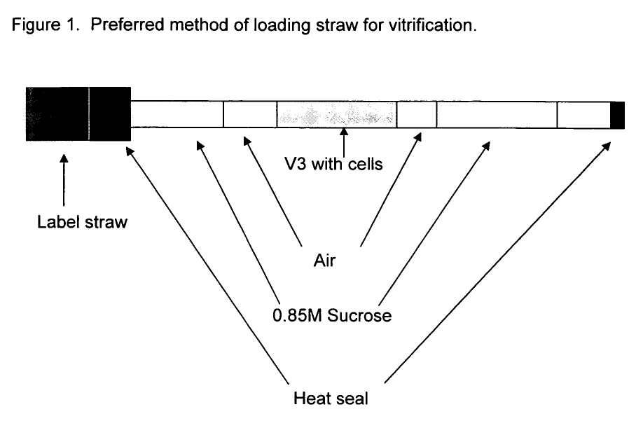

FIG. 2 is a schematic illustrating a method of vitrification of a biological specimen according to the present invention.

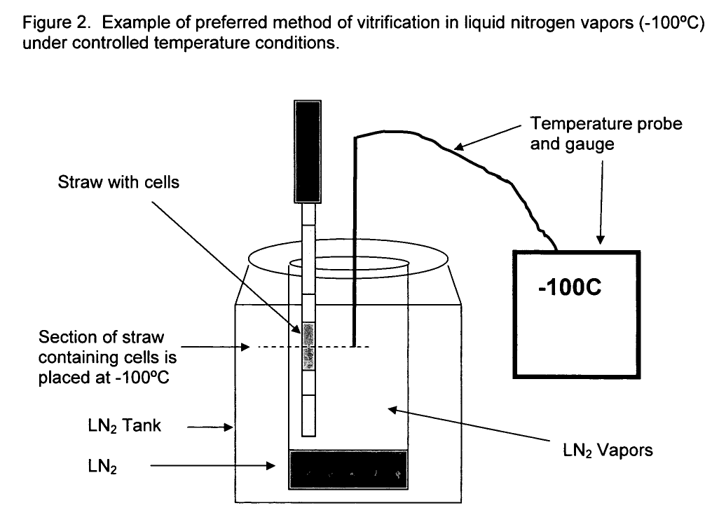

### REFERENCES

Ali J. 2001. Vitrification of embryos and oocytes with 5.5 mol/l ethylene glycol and 1.0 mol/l sucrose. Hum Reprod 16(8):1777-1779.

Chen S U, Lien Y R, Chao K, Lu H F, Ho H N, Yang Y S. 2000. Cryopreservation of mature human oocytes by vitrification with ethylene glycol in straws. Fertil Steril 74(4):804-808.

Cho H J, Son W Y, Yoon S H, Lee S W, Lim J H. 2002. An improved protocol for dilution of cryoprotectants from vitrified human blastocysts. Hum Reprod 17(9):2419-2422.

Chung H M, Hong S W, Lim J M, Lee S H, Cha W T, Ko J J, Han S Y, Choi D H, Cha K Y. 2000. In vitro blastocyst formation of human oocytes obtained from unstimulated and stimulated cycles after vitrification at various maturational stages. Fertil Steril 73(3):545-551.

Cremades N, Sousa M, Silva J, Viana P, Sousa S, Oliveira C, Teixeira da Silva J, Barros A. 2004. Experimental vitrification of human compacted morulae and early blastocysts using fine diameter plastic micropipettes. Hum Reprod 19(2):300-305.

Hiraoka K, Kinutani M, Kinutani K. 2004. Case report: successful pregnancy after vitrification of a human blastocyst that had completely escaped from the zona pellucida on day 6. Hum Reprod 19(4):988-990. Epub 2004 February 2027.

Hong S W, Chung H M, Lim J M, Ko J J, Yoon T K, Yee B, Cha K Y. 1999. Improved human oocyte development after vitrification: a comparison of thawing methods. Fertil Steril 72(1):142-146.

Hotamisligil S, Toner M, Powers RD. 1996. Changes in membrane integrity, cytoskeletal structure, and developmental potential of murine oocytes after vitrification in ethylene glycol. Biology of Reproduction 55(1):161-168.

Hunter J E, Fuller B J, Bernard A, Jackson A, Shaw R W. 1995. Vitrification of human oocytes following minimal exposure to cryoprotectants; initial studies on fertilization and embryonic development. Hum Reprod 10(5): 1184-1188.

Kasai M, Mukaida T. 2004. Cryopreservation of animal and human embryos by vitrification. Reprod Biomed Online 9(2):164-170.

Kuleshova L, Gianaroli L, Magli C, Ferraretti A, Trounson A. 1999. Birth following vitrification of a small number of human oocytes: case report. Hum Reprod 14(12):3077-3079.

Kuleshova L L, Lopata A. 2002. Vitrification can be more favorable than slow cooling. Fertil Steril 78(3):449-454.

Kuleshova L L, Shaw J M. 2000. A strategy for rapid cooling of mouse embryos within a double straw to eliminate the risk of contamination during storage in liquid nitrogen. Hum Reprod 15(12):2604-2609.

Lane M, Schoolcraft W B, Gardner D K. 1999. Vitrification of mouse and human blastocysts using a novel cryoloop container-less technique. Fertil Steril 72(6):1073-1078.

Liebermann J, Dietl J, Vanderzwalmen P, Tucker M J. 2003. Recent developments in human oocyte, embryo and blastocyst vitrification: where are we now? Reprod Biomed Online 7(6):623-633.

Liebermann J, Nawroth F, Isachenko V, Isachenko E, Rahimi G, Tucker M J. 2002. Potential importance of vitrification in reproductive medicine. Biol Reprod 67(6):1671-1680.

Martino A, Songsasen N, Leibo S P. 1996. Development into blastocysts of bovine oocytes cryopreserved by ultra-rapid cooling. Biol Reprod 54(5):1059-1069.

Mukaida T, Nakamura S, Tomiyama T, Wada S, Oka C, Kasai M, Takahashi K. 2003a. Vitrification of human blastocysts using cryoloops: clinical outcome of 223 cycles. Hum Reprod 18(2):384-391.

Mukaida T, Takahashi K, Kasai M. 2003b. Blastocyst cryopreservation: ultrarapid vitrification using cryoloop technique. Reprod Biomed Online 6(2):221-225.

Mukaida T, Wada S, Takahashi K, Pedro P B, An T Z, Kasai M. 1998. Vitrification of human embryos based on the assessment of suitable conditions for 8-cell mouse embryos. Hum Reprod 13(10):2874-2879.

Shaw P W, Bernard A G, Fuller B J, Hunter J H, Shaw R W. 1992. Vitrification of mouse oocytes using short cryoprotectant exposure: effects of varying exposure times on survival. Molecular Reproduction & Development 33(2):210-214.

Son W Y, Yoon S H, Yoon H J, Lee S M, Lim J H. 2003. Pregnancy outcome following transfer of human blastocysts vitrified on electron microscopy grids after induced collapse of the blastocoele. Hum Reprod 18(1):137-139.

Stachecki J J, Cohen J. 2004. An overview of oocyte cryopreservation. Reprod Biomed Online 9(2):152-163.

Vajta G, Holm P, Kuwayama M, Booth P J, Jacobsen H, Greve T, Callesen H. 1998. Open pulled straw (OPS) vitrification: a new way to reduce cryoinjuries of bovine ova and embryos. Molecular Reproduction and Development 51(53-58).

Vanderzwalmen P, Bertin G, Debauche C, Standaert V, Bollen N, van Roosendaal E, Vandervorst M, Schoysman R, Zech N. 2003. Vitrification of human blastocysts with the Hemi-Straw carrier: application of assisted hatching after thawing. Hum Reprod 18(7):1504-1511.

Vanderzwalmen P, Bertin G, Debauche C, Standaert V, van Roosendaal E, Vandervorst M, Bollen N, Zech H, Mukaida T, Takahashi K, Schoysman R. 2002. Births after vitrification at morula and blastocyst stages: effect of artificial reduction of the blastocoelic cavity before vitrification. Hum Reprod 17(3):744-751.

Wu J, Zhang L, Wang X. 2001. In vitro maturation, fertilization and embryo development after ultrarapid freezing of immature human oocytes. Reproduction 121(3):389-393.

Yokota Y, Sato S, Yokota M, Ishikawa Y, Makita M, Asada T, Araki Y. 2000. Successful pregnancy following blastocyst vitrification: case report. Hum Reprod 15(8):1802-1803.

Yokota Y, Sato S, Yokota M, Yokota H, Araki Y. 2001. Birth of a healthy baby following vitrification of human blastocysts. Fertil Steril 75(5):1027-1029.

Yoon T K, Kim T J, Park S E, Hong S W, Ko J J, Chung H M, Cha K Y, Lim J M, Han S Y, Choi D H. 2003. Live births after vitrification of oocytes in a stimulated in vitro fertilization-embryo transfer program. Fertil Steril 79(6):1323-1326.

What is claimed is:

1. A method of vitrification of a biological specimen comprising the steps:
a) treating the biological specimen with a cryoprotectant prior to vitrification; and
b) loading the biological specimen in a container, and
c) sealing the container; and
d) placing the container and the biological specimen into a vitrifying material, such that the biological specimen is indirectly exposed to the vitrifying material thereby undergoing vitrification; and
e) storing the container containing the biological specimen which has undergone vitrification until the biological specimen is ready to be devitrified; and
f) removing the container from the vitrifying material; and
g) allowing the biological specimen to devitrify; and
h) placing the biological specimen in a solution wherein the biological specimen is capable of producing normal young or undergoing further development or able to function for a period of time after the one or more cells are devitrified.

2. A method of vitrification storage and devitrification of one or more developmental cells comprising the steps of:
a) treating the one or more developmental cells consisting of an embryo, a sperm, an oocyte, a blastocyst, or a morula with a cryoprotectant prior to vitrification; and
b) loading the developmental cells in a container selected from the group consisting of a straw, a vial, an ampule, or a similar enclosable holding device of small size, but not an open container consisting of an electron microscopy grid, a loop, a net, or a paddle, and further sealing the container with the developmental cells; and
c) placing the container and the developmental cells into a vitrifying material, such that the developmental cells are indirectly exposed to the vitrifying material thereby undergoing vitrification; and
d) storing the container containing the developmental cells which have undergone vitrification until the developmental cells are ready to be devitrified; and
e) removing the container from the vitrifying material; and
f) allowing the developmental cells to devitrify; and,
g) placing the developmental cells in a solution wherein the developmental cells are capable of producing normal young or undergoing further development or are able to function for a period of time after the developmental cells are devitrified.

3. A kit for vitrification comprising the following components:
a) Instructions for the vitrification method comprising the steps described in claims 1 and claims 2; and
b) Comprising a base vitrification solution, preferably a phosphate-buffered solution containing a protein, preferable 5% to 20%, and
c) Further comprising the cryoprotectants glycerol, ethylene glycol, and sucrose, and
d) Comprising a sealable container(s), preferably a straw(s) for containing the biological specimen during vitrification and storage.
